(19) United States
(12) Patent Application Publication
(10) Pub. No.: US 2021/0033849 A1
(43) Pub. Date: Feb. 4, 2021

(54) Photonic Crystal Risley Prisms

(71) Applicant: US Gov't as represented by Secretary of Air Force, Wright-Patterson AFB, OH (US)

(72) Inventor: Joshua Lentz, Niceville, FL (US)

(21) Appl. No.: 16/922,079

(22) Filed: Jul. 7, 2020

Related U.S. Application Data
(60) Provisional application No. 62/880,164, filed on Jul. 30, 2019.

(51) Int. Cl. G02B 26/08; G02B 26/10; G02B 5/04

(52) U.S. Cl. CPC G02B 26/0891; G02B 5/045; G02B 26/108

(57) ABSTRACT

An optical steering mechanism includes first and second Risley prisms that each comprise spatially variant photonic crystals. A support structure positions the first and second Risley prisms in parallel alignment with at least a selected one of the first and second axially rotatable to the other one to steer a light path through the optical steering mechanism.

### CROSS-REFERENCE TO RELATED APPLICATIONS

This application claims the benefit of priority under 35 U.S.C. § 119(e) to U.S. Provisional Application Ser. No. 62/880,164 entitled “Photonic Crystal Risley Prisms” filed 30 Jul. 2020, the contents of which are incorporated herein by reference in their entirety.

### ORIGIN OF THE INVENTION

The invention described herein was made by employees of the United States Government and may be manufactured and used by or for the Government of the United States of America for governmental purposes without the payment of any royalties thereon or therefore.

### BACKGROUND

### 1. Technical Field

The present disclosure generally relates to optical steering systems and more particularly to use of photonic crystal Risley prisms in optical steering systems.

### 2. Description of the Related Art

A classical approach to optical steering or pointing functions is the utilization of a pair of glass wedge prisms that can be independently rotated. The refraction that occurs as light passes through each prism yields an angular offset.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is a diagram of a generally-known optical steering mechanism that uses two Risley prism positioned in opposition for zero steering of a light path;

FIG. 2 is a diagram of the generally-known optical steering mechanism of FIG. 1 with the two Risley prisms positioned in alignment for an induced angle in the light path.

FIG. 3 is a diagram of a generally-known pointing solution in angular space for a Risley prism pair of FIGS. 1-2;

FIG. 4 is a diagram of a motorized optical steering mechanism that includes Risley prisms formed with photonic crystals and aligned in opposition for zero steering of a light path, according to one or more embodiments; and

FIG. 5 is a diagram of the motorized optical steering mechanism that includes the Risley prisms formed with photonic crystals that are aligned for nonzero induced steering of the light path, according to one or more embodiments.

### DETAILED DESCRIPTION

According to aspects of the present innovation, combined, independently rotated pair of prisms allows the angular offset of each to be used such that an angular region can be pointed to. In particular, presented is the use of specialized photonic crystals that function as Risley prisms to accomplish the same function as generally-known Risley prisms but with lower weight, no central offset, and design degrees of freedom that can provide a solution which is wavelength and polarization agnostic.

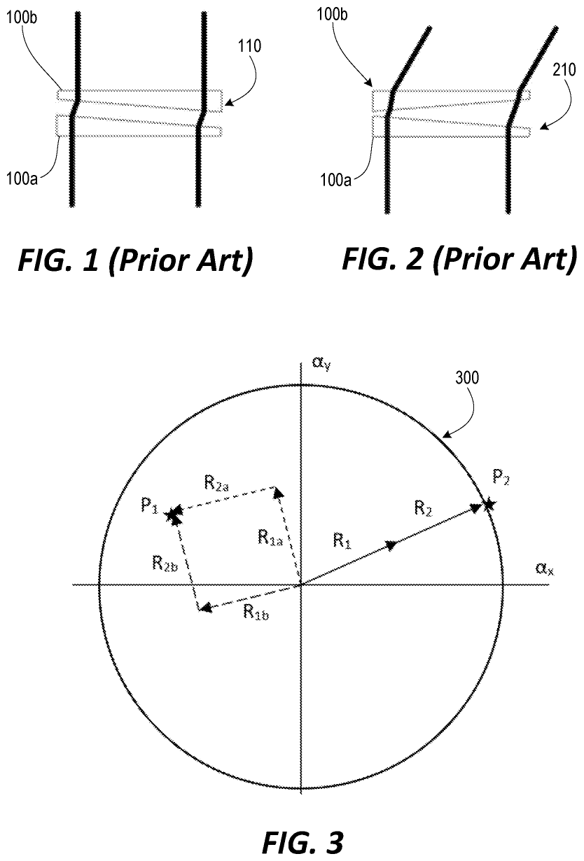

FIGS. 1-2 depict generally-known Risley prism pair 100a-100b that can be used for steering in an opposing orientation 110 (FIG. 1) with no resulting angle or in an aligned orientation 210 (FIG. 2) with an induced angle. The two prisms are rotated to effect various steering angles around the 2D angular region of interest. Risley prism pairs 100a-100b are basic wedge prisms that have been used for decades to provide optical pointing and steering functions. Typically, they exist in pairs and are rotated independently of each other, allowing energy to be steered over a hemisphere of space, with the limitation in angular precision being established primarily by the precision of rotation of the prisms. The steering function is a result of the refraction-induced angular change of light passing through the prism. The magnitude of angular change is fixed for a given prism but the direction of the output light can be adjusted by rotating the prism.

FIG. 3 depicts a diagram 300 of a generally-known pointing solution in angular space for a Risley Prism pair 100a-100b (FIG. 1). With Risley prism pair 100a-100b (FIG. 1), the entire angular range from on-axis to twice the angular shift of a single prism can be accomplished. The function of Risley prisms is demonstrated in FIG. 3. For the case of a point on the outer circle defining the range of pointing of the Risley prisms, a point P2 in angular space can be reached with exactly one solution, the case of both prisms being rotated to the same axial position such that the angular change of light is doubled. In the case of a generic point P1 within the pointing range and not at the axial (0 angle) position of the pointing, two complementary solutions exist. The two solutions correspond to reversing the order of prism rotation (i.e. in solution 1, prism 1 is rotated by x and prism 2 is rotated by y, and for solution 2, prism 1 is rotated by y and prism 2 is rotated by x). The vectoral sum of the prism pointing in angle space is the same for both.

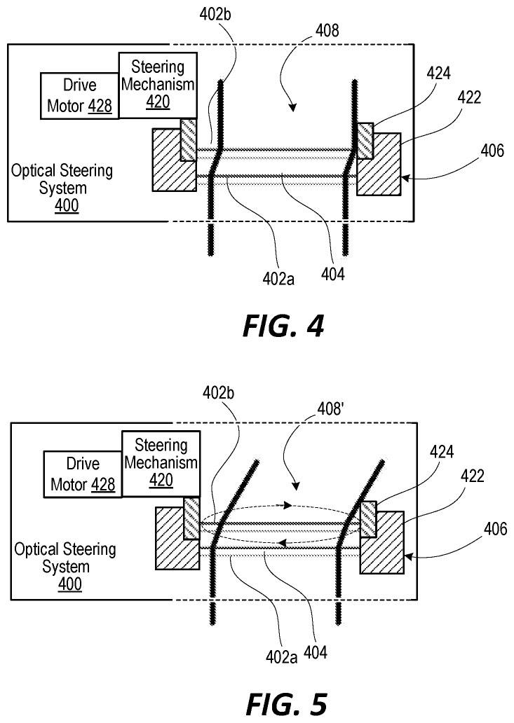

According to aspects of the present innovation, FIGS. 4-5 depict an optical steering system 400 that uses a pair of first and second Risley prisms 402a-402b that each comprise spatially variant photonic crystals 404. A support structure 406 positions the first and second Risley prisms 402a-402b in parallel axial alignment with at least a selected one of the first and second Risley prisms 402a-402b axially rotatable to the other one to steer a light path 408 through the optical steering mechanism 400. In FIG. 4, the first and second Risley prisms 402a-402b with spatially variant photonic crystals 404 are rotated into opposition for steering the light path 408 with no angle. In FIG. 5, the first and second Risley prisms 402a-402b with spatially variant photonic crystals 404 are rotated into alignment to steer the light path 408′ with an induced angle. The first and second Risley prisms 402a-402b with spatially variant photonic crystals 404 are rotated to effect various steering angles around the two dimension (2D) angular region of interest. In one or more embodiments, polarization gratings can be used instead of photonic crystal beam steering to also accomplish either steering with no angle or with an angular offset. The first and second Risley prisms 402a-402b with spatially variant photonic crystals 404 and polarization gratings can be used in a completely analogous manner to the Risley prism pair but with no induced aberrations.

In one or more embodiments, optical steering mechanism 400 depicted in FIGS. 4-5 can include a motorized steering mechanism 420. The support structure 406 includes a housing 422 attached to the first Risley prism 402a. A rotational sleeve 424 is annularly attached to the second Risley prism 402b and rotatably engaged to the housing 422. The motorized steering mechanism 420 includes a steering drive motor 428 that is in geared engagement the steering mechanism 420 that selectively rotates the rotational sleeve 424 in the housing 422 to adjust the light path 408 through the optical steering mechanism 400.

The last case of the Risley prisms is for axial steering. Whereas a point on the outer circle has exactly one solution, a point in the interior, non-zero region has two solutions, the zero point has infinite solutions. In this case the choice of rotation on one prism is arbitrary and the second prism is required to be rotated in exactly the opposite direction such that the vector sum of the two is zero. In this case, as can be seen in FIG. 4, a lateral shift of the optical energy occurs, the magnitude of the shift depending on the prism angle and the spacing between prisms.

The function of Risley prisms can be accomplished via any mechanism that results in a fixed angular offset of light. In the case of Risley gratings [1], diffraction is used to generate the angular offset by sending all of the light into a particular nonzero diffracted order of a specialized grating, typically in a polymerized grating form. This technique allows a very lightweight solution to Risley functions, reducing the demand on rotation stages and associated motor control as well as eliminating the chromatic aberration associated with the prism. The disadvantage of the Risley grating is that 50% of the original source light is likely to be lost through a polarization process needed to reduce the grating to a single order output. In some cases, a circularly polarized source can be used in which case the loss would not occur.

An additional method for the angular deviation of light is a particularly designed photonic crystal structure. In order for the photonic crystals to have the beam diverting properties necessary, they must be spatially variant photonic crystals [2-5]. These have recently been reported to be self-collimating while re-directing energy at an angle of 90 degrees [2-3]. Other, lower angular deviations are also possible using the same design and fabrication techniques. Designs could theoretically be extended to achromatic function. Note that the offset that occurs for Risley prisms in the on-axis case can be minimized since the separation of thin elements is easier to accomplish than for thick prisms.

Fabrication methods are generally specific to the photonic crystal design selected. As such, fabrication methods for this invention cannot be prescribed in general, but several methods are available in literature [4-9] and several methods have been patented [13-17]. The fabrication of the Risley elements is particular to the choice of elements chosen.

To employ aspects of the present disclosure, given that Risley elements are already available, one must determine the maximum shift of the exit pupil from natural position to the position at maximum field angle. Next, for any desired angle, the steering angles of each pair of Risley elements must be determined. An analytical solution is not available for all scenarios, but a numerical optimization to minimize the shift of the exit pupil works well. This can use a variety of advanced methods, or if applications do not demand precision, a brute force method is sufficient.

Once Risley element settings are determined for each pair of elements, the elements must be rotated to the correct positions. In one or more embodiments, additional Risley photonic crystal elements can be included to expand the range of angles, increase accuracy or increase system speed.

The following references [1-17] cited above are hereby incorporated by reference in their entirety:

[1] Chulwoo Oh, Chulwoo Oh, Jihwan Kim, Jihwan Kim, John F. Muth, John F. Muth, Michael J. Escuti, Michael J. Escuti,} “A new beam steering concept: Risley gratings”, Proc. SPIE 7466, Advanced Wavefront Control: Methods, Devices, and Applications VII, 74660J (11 Aug. 2009); doi: 10.1117/12.828005; https://doi.org/10.1117/12.828005.

[2] Rumpf, R. C., Pazos, J. J., Digaum, J. L., & Kuebler, S. M. (2015). Spatially variant periodic structures in electromagnetics. Philosophical Transactions of the Royal Society A: Mathematical, Physical and Engineering Sciences, 373(2049).

[3] Jennefir L. Digaum, Rashi Sharma, Daniel Batista, Javier J. Pazos, Raymond C. Rumpf, Stephen M. Kuebler, “Beam-bending in spatially variant photonic crystals at telecommunications wavelengths”, Proc. SPIE 9759, Advanced Fabrication Technologies for Micro/Nano Optics and Photonics IX, 975911 (14 Mar. 2016)

[4] Pazos, j. (2010). Digitally manufactured spatially variant photonic crystals. Phd. University of Texas at El Paso.

[5] Liu, Longju & Hurayth, Abu & Li, Jingjing & Hillier, Andrew & Lu, Meng. (2016). A strain-tunable nanoimprint lithography for linear variable photonic crystal filters. Nanotechnology. 27. 295301.

[6] Liu, Xiaojun & Da, Yun & Xuan, Yimin. (2017). Full-spectrum light management by pseudo-disordered moth-eye structures for thin film solar cells. Optics Express. 25. A824.

[7] Beaulieu, Michael & Hendricks, Nicholas & Watkins, James. (2014). Large-Area Printing of Optical Gratings and 3D Photonic Crystals Using Solution-Processable Nanoparticle/Polymer Composites. ACS Photonics.

[8] Sun, Tangyou & Xu, Zhimou & Xu, Haifeng & Zhao, Wenning & Wu, Xinghui & Liu, Sisi & Ma, Zhichao & He, Jian & Liu, Shiyuan & Peng, Jing. (2013). Photonic crystal structures on nonflat surfaces fabricated by dry lift-off soft UV nanoimprint lithography. Journal of Micromechanics and Microengineering. 23.

[9] Calafiore, Giuseppe & Fillot, Quentin & Dhuey, Scott & Sassolini, Simone & Salvadori, Filippo & Prada, Camilo & Munechika, Keiko & Peroz, Christophe & Cabrini, Stefano & Piña-Hernandez, Carlos. (2016). Printable photonic crystals with high refractive index for applications in visible light. Nanotechnology. 27.

[10] U.S. Pat. No. 9,195,092, Escuti , et al., “polarization-independent liquid crystal display devices including multiple polarizing grating arrangements and related devices”, issued Aug. 15, 2013.

[11] U.S. Patent Publ. No. 2016/0259090, Jiang, et al., “Photonic crystal supporting high frequency sensitivity self-collimation phenomenon and design method and use thereof”, published Sep. 8, 2016.

[12] U.S. Patent Publ. No. 2017/0123288, Dmitriev, et al., “Compact optical key based on a two-dimensional photonic crystal with 120 degree folding”, published May 4, 2017.

[13] U.S. Pat. No. 9,726,83, Perrier-cornet, et al., “Methods and systems for thermal printing of photonic crystal materials, and thermally Printable photonic crystal materials and assemblies”, 2017

[14] U.S. Patent Publ. No. 20160161822, Kim, et al., “Smart glass using guided self-assembled photonic crystal”, published Jun. 9, 2016.

[15] U.S. Patent Publ. No. 20170159206, Li, et al., “Method of making photonic crystal”, published Jun. 8, 2017.

[16] U.S. Pat. No. 8,610,853, Escuti , “Methods of fabricating optical elements on substrates and related devices,” Dec. 19, 2012.

[17] U.S. Pat. No. 8,358,400, Escuti , “Methods of fabricating liquid crystal polarization gratings on substrates and related devices” Jan. 22, 2013.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. An optical steering system comprising:
a first Risley prism comprising spatially variant photonic crystals;
a second Risley prism comprising spatially variant photonic crystals; and
a support structure that positions the first and second Risley prisms in parallel alignment with at least a selected one of the first and second axially rotatable to the other one to steer a light path through the optical steering mechanism.

2. The optical steering system of claim 1, wherein the support structure comprises:
a housing attached to the first Risley prism;
a rotational sleeve attached to the second Risley prism and rotatably engaged to the housing;
a motorized steering drive that selectively rotates the rotational sleeve in the housing to adjust the light path through the optical steering mechanism.
